(19) United States
(12) Patent Application Publication
(10) Pub. No.: US 2014/0200980 A1
(43) Pub. Date: Jul. 17, 2014

(54) SYSTEM AND METHOD FOR MEDIATING TRANSACTIONS AMONG A PLURALITY OF SOCIAL COMMERCE BUSINESSES

(71) Applicants: Jae Kyoung Bang, Seongnam-si (KR); Hae Ryung Kim, Seongnam-si (KR); Eun-Young Bang, Seongnam-si (KR)

(72) Inventors: Jae Kyoung Bang, Seongnam-si (KR); Hae Ryung Kim, Seongnam-si (KR); Eun-Young Bang, Seongnam-si (KR)

(21) Appl. No.: 14/240,998

(22) PCT Filed: Jul. 12, 2012
(86) PCT No.: PCT/KR2012/005528

§ 371 Date: Feb. 25, 2014

(30) Foreign Application Priority Data
Aug. 30, 2011 (KR) 10-2011-0086893

(51) Int. Cl. G06Q 20/12; G06Q 30/06; G06Q 50/00; G06Q 30/02

(52) U.S. Cl. CPC G06Q 20/12; G06Q 30/0222; G06Q 30/0633; G06Q 50/01
USPC 705/14.23

(57) ABSTRACT

A system and method for mediating transactions among a plurality of social commerce businesses, which enable social commerce businesses to provide one large social commerce community and mediate transactions among the businesses to thereby provide a sound social commerce market in which the businesses compensate for weak points and achieve win-win results and enable transactions with overseas as well as domestic social commerce businesses. An embodiment of the transaction mediation computer converts specifications related to transactions to the format required by or suitable for a relevant social commerce businesses and provides the format such that transactions may be performed regardless of the nationality of the social commerce businesses, and accesses an electronic customs procedure computer and computers of domestic and overseas delivery companies so as to control the customs procedure and domestic and overseas delivery process.

### TECHNICAL FIELD

The present invention relates to system and method for intermediating transactions among a plurality of social commerce businesses and especially regarding transaction system between multiple social commerce businesses made possible by sharing the distribution route of discount coupons.

### BACKGROUND ART

Social commerce is a term that refers to electronic commerce through social network service such as Facebook, Twitter, Kakao Talk and others wherein group purchase method that Groupon has pioneered is the most well-known type of social commerce. Group buying in social commerce, also known as social shopping is a sales method wherein exceptional discount rate will be provided when more than certain numbers of buyers are gathered to purchase the item. The term ‘group buying in social commerce’ derives from the fact that people make use of social network services when they look for other people who are interested in group purchases. Wide usage of smart phones has accelerated the spread of social commerce business by providing the environment where people can use social network services anytime and anywhere.

Patent Publication 1 discloses ‘Method and Device for Cross-selling between Electronic Commerce Website’ wherein products that are sold independently and separately in websites for electronic commerce are also sold in other online shopping malls, online community, blogs and portal websites by borrowing certain amount of space or by lending the space for products from other online shopping malls and also sells the products that are available in other online shopping malls through intermediation device or by providing the method of cross-selling between websites.

Patent Publication 2 discloses effective method regarding ‘System and Method of Intermediation between Websites’ which enables mutual contribution of products and services through platform for electronic commerce intermediation.

Patent Publication 3 discloses ‘Unified Intermediation Management System and Method for Mobile Coupon between Websites’ wherein structured data format is provided instead of mobile text message coupon to be sent to unified intermediation and management system to provide convenience and variety for people who purchased the coupons as well as providing reliability and feedback after coupon usage for company that issued the coupon. Marketing and profit margin related information is provided to the mediating company in order to maximize mutual profit.

Patent Publication 4 discloses ‘System and Server for Method of Selling Products Online’ wherein website that sells product and separate web pages for each product that are connected through multiple terminals and networks.

### PRIOR ART

Patent Publication 1: KR 10-2006-0068368 A 2006.06.21
Patent Publication 2: KR 10-2010-0089760 A 2010.08.12
Patent Publication 3: KR 10-2011-0041457 A 2011.04.21
Patent Publication 4: KR 10-1037792 B1 2011.05.23

### SUMMARY OF INVENTION

### Technical Problem

Current social commerce market is continuing to be on the decline and becoming more isolated due to cutthroat competitions that are bleeding the businesses dry. Moreover, customers are unable to receive high quality services due to competition with self-serving motives between social commerce businesses which prevents other social commerce companies from securing partner companies and products. Overseas social commerce businesses that infiltrated domestic market pose a threat to domestic social commerce businesses with comparatively less capital and less connections.

Purpose of the present invention is to create trustworthy social market wherein the social commerce businesses form one big community with ongoing intermediate transactions that help each other overcome weaknesses and develop mutually beneficial relationship wherein transactions with overseas social commerce businesses will take place wherein it is not limited to domestic businesses which will provide various type of products that can be conveniently purchased with low prices wherein the sellers are able to sell and promote the products from their company to larger areas to overseas customers with lower cost.

Purpose of the present invention in more detail is as follows.
1. Purpose of the present invention is to provide social commerce businesses that are having a hard time securing partner companies with various products from other social commerce companies through intermediate transaction to sell them as their own in order to provide various types of product to the customers;
2. Purpose of the present invention is to provide social commerce businesses that are having a hard time securing more customers with the opportunity to secure customers who are registered with social commerce business as buyers as their clientele;
3. Purpose of the present invention is to provide the customers with convenience of purchasing products from overseas without the restriction of registering with other social commerce businesses;
4. Purpose of the present invention is to expand customer pool for specific products in order to increase the chance of group buying process to successfully take place;
5. Purpose of the present invention is to provide method wherein social commerce businesses can help each other overcome their weaknesses by simply registering for intermediate transaction without merger or takeover between the companies;
6. Purpose of the present invention is to provide large scale international social commerce market that can be trusted.

### Solution to Problem

In order to solve the above problem, intermediate transaction system and method which provides transaction related information after processing the information into a required or a suitable format for social commerce business through computer used for intermediate transaction in order to enable international transactions to take place without any restrictions and to control the process of customs procedure and delivery by accessing electronic customs procedure computer and computer used in international shipping service company in accordance with the present invention.

### Advantageous Effects

According to the present invention, social commerce business will be able to expand the market by selling and purchasing various coupons by securing the customers of other social commerce businesses as clientele of their partner company or as their own wherein intermediate transaction company will be able to soundly expand the social commerce market to overseas and customers will be able to purchase products from other partner companies by registering with one social commerce business without the hassle of registering with other social commerce businesses.

### BRIEF DESCRIPTION OF THE DRAWINGS

FIG. 1 is a block diagram illustrating the outline of intermediate transaction system between multiple social commerce businesses according to the embodiment of present invention.

FIG. 2 is a block diagram illustrating specific details of intermediate transaction system between multiple social commerce businesses according to the embodiment of present invention.

FIG. 3 is a block diagram illustrating specific details of internal configuration of computer for intermediate transaction in FIG. 1 according to the embodiment of present invention.

FIG. 4 is a flowchart illustrating the outline of intermediate transaction between multiple social commerce businesses according to the embodiment of present invention.

FIG. 5 is a flowchart illustrating the process wherein computer used for social commerce business requests the computer for intermediate transaction to perform intermediary transaction task in preparation for intermediate transaction according to the embodiment of present invention.

FIG. 6 is a flowchart illustrating the process wherein computer used for social commerce business requests the computer for intermediate transaction to perform coupon information and transaction requirement process according to the embodiment of present invention.

FIG. 7 is a flowchart illustrating the process of coupon being ordered and coupon being cancelled according to the embodiment of present invention.

FIG. 8 is a flowchart illustrating the process of payment being calculated after the transaction had been completed according to the embodiment of present invention.

FIG. 9 is a flowchart illustrating the process of international shipping process and custom clearance process during the transaction between international social commerce businesses according to the embodiment of present invention.

FIG. 10 is a flowchart illustrating the process of product being processed for domestic deliver service after it had been internationally shipped or cleared from the customs during the transaction between international social commerce businesses according to the embodiment of present invention.

FIG. 11 is a flowchart illustrating the process of providing the information regarding customer satisfaction of social commerce business and popularity of the coupon as result of the transaction according to the embodiment of present invention.

FIG. 12 is a block diagram illustrating the flow of payment process and delivery process during international transaction according to the embodiment of present invention.

### DETAILED DESCRIPTION OF THE PREFERRED EMBODIMENT

Various embodiments of the disclosure are discussed in detail below in reference to the drawings.

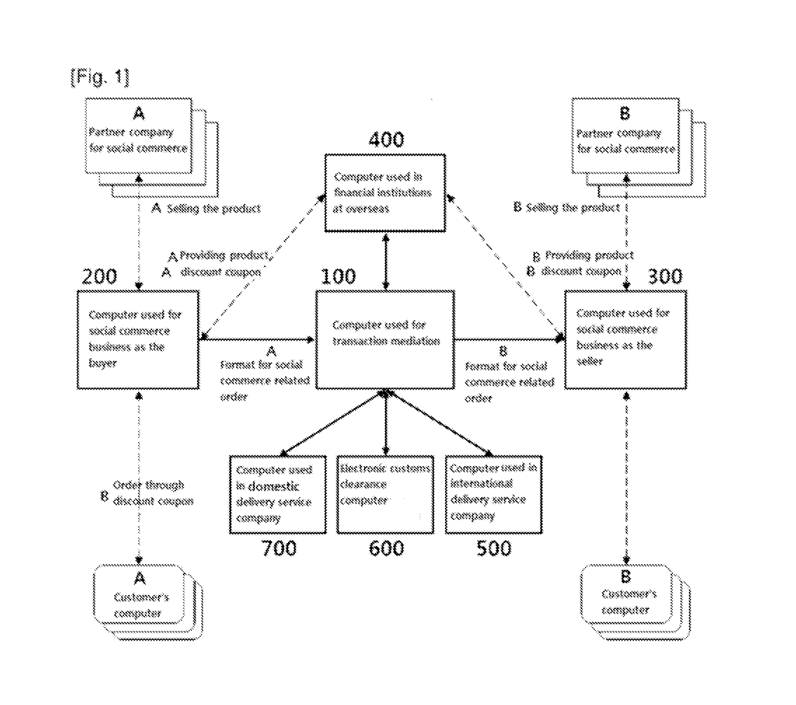

FIG. 1 is a block diagram illustrating the outline of intermediate transaction system between multiple social commerce businesses according to the embodiment of present invention.

As it had been illustrated, ‘System and method for mediating transactions among a plurality of social commerce businesses’ of the present invention comprises of computer used for intermediate transaction 100, multiple computers used for social commerce business as the buyer for purchasing the coupons 200, multiple computers used for social commerce business as the seller for selling the coupons 300, computer used in financial institutions 400, computer used by international shipping service company 500, electronic customs procedure computer used by Customs Bureau 600 and including the computer used by domestic shipping service company 700.

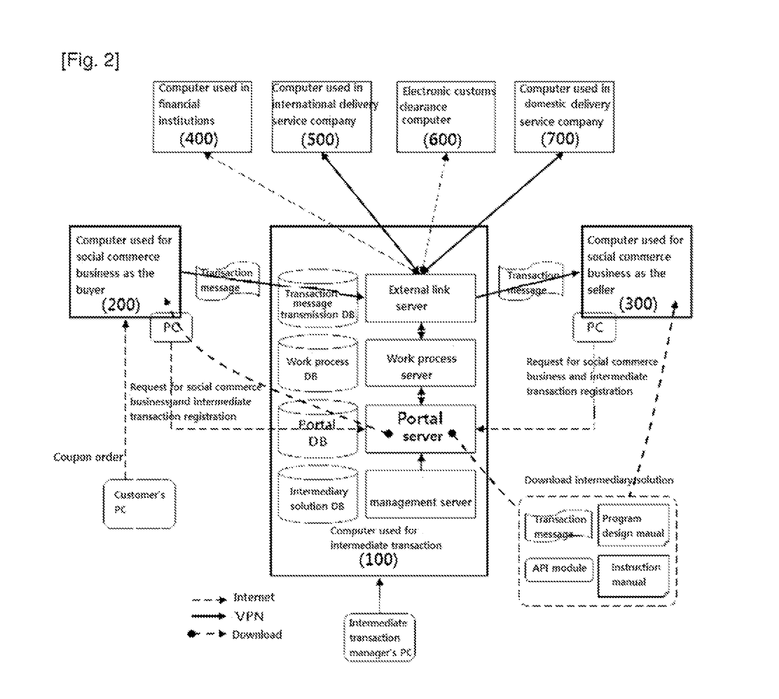

FIG. 2 is a block diagram illustrating specific details of intermediate transaction system between multiple social commerce businesses according to the embodiment of present invention.

‘System and method for mediating transactions among a plurality of social commerce businesses’ is connected with related systems, private line or internet and other various network wherein it is recommended that private network and private lines be used since multiple social commerce business computers transmit and receive information regarding coupon orders and payment processing with the system. Furthermore, messages that are transmitted and received should be encrypted in order to solve problems related with security.

It is recommended that computer used for intermediate transaction 100 would comprise of separate components such as external link server needed in order to receive and transmit the message with various systems such as multiple computers used for social commerce business as the buyer for purchasing the coupons 200, multiple computers used for social commerce business as the seller for selling the coupons 300, computer used in financial institutions 400, computer used in international shipping service company 500, electronic customs procedure computer used in Customs Bureau 600 and including the computer used in domestic shipping service company 700; portal server and transaction related information which is needed in order to download the intermediary solution that includes program design manual and instruction manual which are needed in order to develop the program that needs to be installed in computers used in social commerce business for intermediate transaction and for task processing server used for internal task processing purposes, multiple social commerce business computers as it requests intermediate transaction related task or processes information through the web, transaction message needed in order to establish the system and the API module; and intermediate solution management server to maintain and manage API module, program design manual and instruction manual.

Moreover, computer used for intermediate transaction 100 can be set up as duplex computer system in order to continuously provide services in case any error occurs wherein disaster prevention center in case of serious disaster befalling the main intermediate transaction computer.

Social commerce businesses can download the intermediary solution which includes standard API module needed for interface as well as program design manual and instruction manual from the portal server to be applied to their respective system upon receiving approval after requesting for registration to computer used for intermediate transaction 100 for the first time in order to proceed with the intermediate transaction.

FIG. 1, 2, 12 and Table 1 as seen below is used as reference to provide details for each component of ‘System and method for mediating transactions among a plurality of social commerce businesses’ according to the present invention.

Computer used for intermediate transaction 100 creates table with basic information of social commerce businesses T1 after receiving intermediate transaction registration request through the web portal wherein task of registration approval is carried out after it meets the prerequisite conditions for approval wherein social commerce business which had been approved can download intermediary solution which includes transaction message needed for mutual intermediate transaction, standard API module for transmission and reception interface as well as program design manual and instruction manual from the web portal.

Computer used for intermediate transaction 100 reads the coupon sales reservation table T2 wherein the information regarding sales reservation that had been stored by computer used for social commerce business as the seller 300 wherein coupon information table T4 and coupon transaction condition table T5 is created after receiving the confirmed coupon information and conditions for transaction in regards to the products that had been reserved by the computer used for social commerce business as the seller 300 wherein the approximated date for sales is drawing closer.

Then, the computer used for intermediate transaction 100 calculates the amount for international shipping, customs charge and domestic shipping charge in case where the coupon transaction is between international social commerce businesses wherein the information will be additionally added to coupon transaction condition table T5 wherein finalized coupon information and transaction condition would be sent to computer used for social commerce business as the buyer 200 and when the approval for transaction had been received, preparation for transaction such as creating coupon order status table T6 would be carried out.

Moreover, computer used for intermediate transaction 100 translates or processes coupon information file that it received from computer used for social commerce business as the seller 300 into desired format that computer used for social commerce business as the buyer 200 that had approved the transaction wants.

Afterwards, computer used for intermediate transaction 100 creates order history table for social commerce business as the buyer T7 or cancellation history table for social commerce business as the buyer T10 after receiving the coupon order or cancellation from multiple computers used for social commerce business as the buyer 200 wherein coupon order related transaction ledger table T8 or coupon order cancellation transaction ledger table T11 is created after conditions are met wherein information such as status of the coupon such as expiration or exceeded sales amount had been checked. Order history table of social commerce business as the seller T9 or cancellation history table of social commerce business as the seller T12 is created according to the message format as agreed upon with the computer used for social commerce business as the seller 300 wherein order or order cancellation is sent to computer used for social commerce business as the seller 300 to carry out the function of order or order cancellation related tasks.

At the time of deadline, computer used for intermediate transaction 100 receives information about the deadline of the corresponding coupon from computer used for social commerce business as the seller 300 to end the transaction related to the corresponding coupon wherein it sends the cancellation request to computer used for social commerce business as the buyer 200 and computer used for social commerce business as the seller 300 for the cancellation of entire coupon transaction takes place if the number of coupon that were sold is less than the minimum sales amount after information regarding the deadline was sent to computer used for social commerce business as the buyer 200.

When sales amount of corresponding coupon exceeds the minimum sales amount as specified by condition of the transaction, transaction history in computer used for intermediate transaction 100 compared wherein coupon transaction ends after coupon payment related transaction ledger table T13 is created given that the information is consistent.

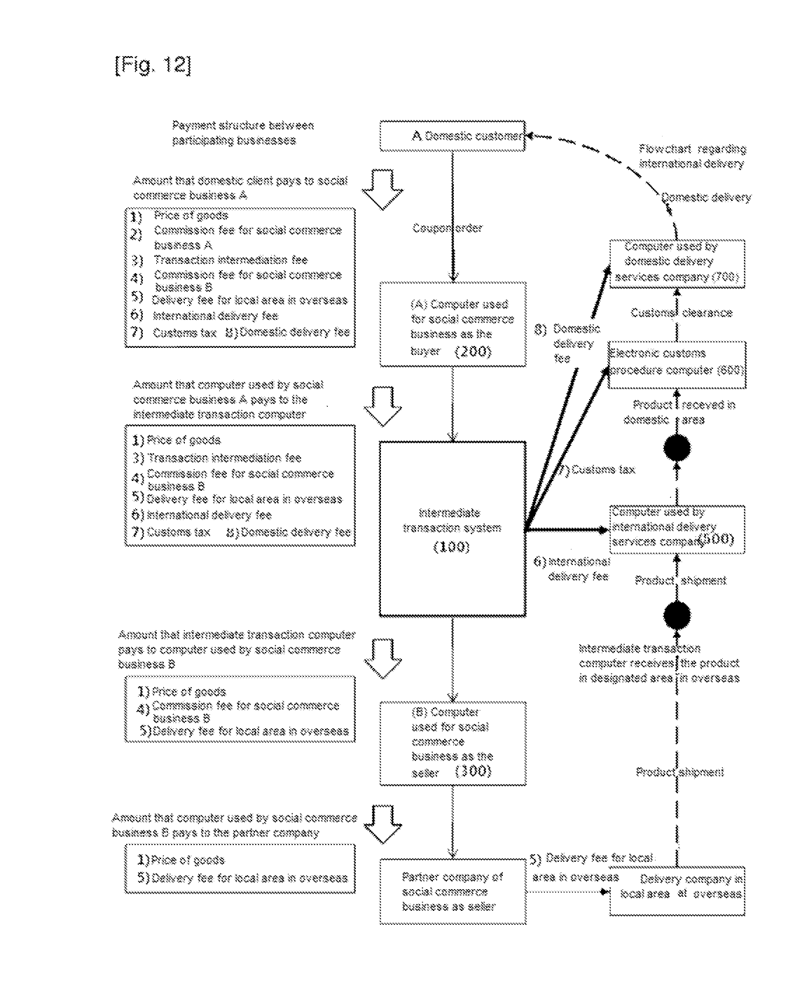

Afterwards, computer used for intermediate transaction 100 requests the payment deposit to computer used for social commerce business as the buyer 200 wherein payment completion is checked through 400 where payment deposit process is carried out when the deposit has been made. Payment notice is given out to computer used for social commerce business as the seller 300 and the payment is made to computer used for social commerce business as the seller 300 through computer used in financial institutions 400 at the payment date wherein task completion related process takes place after. In reference to FIG. 12, it is clearly shown that the amount of money paid by computer used for social commerce business as the buyer 200 and paid to computer used for social commerce business as the seller 300 excludes commission fee as stated in the condition regarding coupon transaction.

When the transaction is between international social commerce businesses, responsibility to deliver the ordered product to the customer in the domestic area is with the intermediary company between social commerce businesses. In reference to FIG. 12, computer used for intermediate transaction 100 receives the ordered product from the partner company of social commerce business in overseas wherein international shipping process is carried out through the computer used by international shipping service company 500 as international shipping information table for coupon T15 is created wherein custom clearance process is carried out through the electronic customs procedure computer 600 by creating customs related information table for coupon T16 when the ordered product needs to be cleared by the customs.

In order to deliver the orders to customers, domestic shipping information table for coupon T17 is created and domestic shipping is carried out through computer used by domestic shipping service company 700.

Moreover, computer used for intermediate transaction 100 orders fund transfer and checks the result of the fund transfer through the computer used in financial institutions 400 for payment deposit and the payment process needed in each stage of the transaction between social commerce businesses wherein computer used for intermediate transaction 100 analyzes the transaction history of the coupon and evaluates the popularity of the coupon to create coupon evaluation information table T18 after transaction between social commerce businesses has ended. Transaction history of social commerce business as seller and buyer are analyzed per cycle to create social commerce business related evaluation information table T19 wherein function of sending the information to social commerce businesses is also carried out per cycle. Function that terminates intermediate transaction with social commerce business is activated when evaluation result is below set standard in accordance with the evaluation results.

Moreover, computer used for intermediate transaction 100 also provides basic information regarding social commerce business, general information regarding coupon transaction, general information regarding coupon order and coupon cancellation, general information regarding deadline of the coupon transaction, status regarding international and domestic shipment of the coupon, status regarding payment and deposit for coupon related transaction and general information regarding result of the coupon related transaction to participating companies according to their information access level while mediating transactions between social commerce businesses in order for all the participating business entities to have general access to various information that they need.

Moreover, computer used for intermediate transaction 100 carries out the task of developing, testing and managing intermediary solution by creating or modifying the transaction message format, corresponding API module, program design manual and instruction manual in order to maintain the solution in optimal condition when new services, functions or technology is applied during intermediate transaction between social commerce businesses.

Moreover, computer used for intermediate transaction 100 also carries out the task of monitoring the status of the network, real-time monitoring to prevent error of the servers, controls the transmission of messages between businesses, monitoring the various processes needed for intermediate transaction and their current status, regular data deletion and backup process for optimization of various data that are created and stored during transaction as it is connected to computer used for social commerce business as the buyer 200, computer used for social commerce business as the seller 300, computer used in financial institutions 400, computer used by international delivery services company 500, electronic customs procedure computer 600, computer used by domestic delivery services company 700 through internet, virtual private network, private line and other communications network.

TABLE 1

| | | |
|---|---|---|
| T1 | Basic information of | Social commerce business ID, name of the social |
| | social commerce | commerce business, name of the shipowner, URL, |
| | businesses | company address, main contact number, country, |
| | | area, IP address, person in charge, e-mail of the |
| | | person in charge, phone number of the person in |
| | | charge, bank code, name of the bank, location of |
| | | the bank, KRW bank account number, foreign |
| | | currency account number, person in charge of the |
| | | fund, check consent form 1, check consent form 2, |
| | | check registration, grounds for registration related |
| | | rejection, stopping the transaction, date when the |
| | | transaction stopped |
| T2 | Coupon selling | Scheduled date of sale, ID for social commerce |
| | related reservation | business as seller, Daily Seq, coupon reservation |
| | | registration date, country that issued the coupon, |
| | | area that issued the coupon, country that wishes to |
| | | sell the coupon, area that wishes to sell the |
| | | coupon, estimated price of the coupon, share rate |
| | | for expected commission, introducing outline of the |
| | | discount coupon, request related |
| T3 | Sequence for internal | Coupon classification, year, coupon classification |
| | coupon ID | name, January to December |
| T4 | Coupon information | Internal coupon ID, coupon name, ID of social |
| | | commerce business as the seller, coupon ID of the |
| | | other party during transaction, introduction to the |
| | | coupon of the other party, file name, country that |
| | | issued the coupon, country that wishes to sell the |
| | | coupon, area that wishes to sell the coupon, |
| | | minimum amount of sales, date of the first sale, |
| | | date when the sale ends, whether the payment |
| | | process has ended, whether the shipment had |
| | | been completed |
| T5 | Conditions for coupon | Internal coupon ID, coupon name, ID of social |
| | transaction | commerce business as the buyer, specific type, |
| | | specific type of coupon of the other party, file name |
| | | of the coupon introduction from the transaction |
| | | process initiator, type of transaction, sale amount |
| | | in the local area, commission fee for local area |
| | | delivery, commission share rate, international |
| | | delivery commission fee, custom clearance, |
| | | commission fee for international delivery, |
| | | commission fee for domestic delivery, sale amount |
| | | in the domestic area, custom clearance fee, |
| | | domestic sales amount, transaction approval |
| T6 | Status regarding | Internal coupon ID, specific type, status regarding |
| | coupon related order | the deadline, internal coupon order number |
| | | sequence, number of current orders, number of |
| | | current order cancellation, approximate time for the |
| | | deadline (local time) |
| T7 | Order history of social | Internal coupon ID, ID of social commerce |
| | commerce business | business as the buyer, specific type, coupon order |
| | as the buyer | number for social commerce business as the |
| | | buyer, order number for internal coupon number, |
| | | type of order, date of order, person who placed the |
| | | order, shipping address of person who placed the |
| | | order, e-mail of the person who placed the order, |
| | | phone number of person who placed the order, |
| | | time of order, quantity of the order, payment in |
| | | KRW, payment in foreign currency |
| T8 | Coupon transaction | Internal coupon ID, ID of social commerce |
| | ledger | business as the buyer, specific type, internal |
| | | coupon order number, type of order, coupon order |
| | | number of the transaction initiator, date of order, |
| | | type of transaction, person who placed the order, |
| | | shipping address of person who placed the order, |
| | | e-mail of the person who placed the order, phone |
| | | number of person who placed the order, time of |
| | | order, quantity of the order, payment in KRW, |
| | | payment in foreign currency, status of the order, |
| | | code regarding completion of domestic delivery |
| T9 | Order history of social | ID of social commerce business as the seller, ID of |
| | commerce business | other party in transaction, specific type of coupon |
| | as the seller | of other party in transaction, internal coupon ID, ID |
| | | of social commerce business as the buyer, specific |
| | | type, internal coupon order number, type of order, |
| | | date of order, person who placed the order, |
| | | shipping address of person who placed the order, |
| | | e-mail of the person who placed the order, phone |
| | | number of person who placed the order, time of |
| | | order, quantity of the order, ID of the person who |
| | | placed the order |
| T10 | Cancellation history | Internal coupon ID, ID of social commerce |
| | of company related | business as the buyer, specific type, coupon order |
| | order for social | number of the transaction initiator, type of order, |
| | commerce business | order cancel date, order cancel time, quantity of |
| | as the buyer | cancelled order, cancelled amount in KRW, |
| | | cancelled amount in foreign currency |
| T11 | Coupon order | Internal coupon ID, ID of social commerce |
| | cancellation | business as the buyer, specific type, internal |
| | transaction | coupon order number, type of order, coupon order |
| | ledger | |
| | | number of the transaction initiator, date of |
| | | cancellation, person who cancelled the order, time |
| | | of cancellation, quantity of cancelled order, |
| | | cancelled amount in KRW, cancelled amount in |
| | | foreign currency, cancelled status |
| T12 | Cancellation history | ID of social commerce business as the seller, |
| | of company related | coupon ID of other party in transaction, specific |
| | order for social | type of coupon of other party in transaction, |
| | commerce business | internal coupon ID, ID of social commerce |
| | as the seller | business as the buyer, specific type, internal |
| | | coupon order number, type of order, date of order |
| | | cancellation, time of order cancellation, quantity of |
| | | cancelled order, type of cancellation, ID of person |
| | | who cancelled the order, person who cancelled the |
| | | order |
| T13 | Coupon payment | Internal coupon ID, ID of social commerce |
| | related transaction | business as the buyer, specific type, total amount |
| | ledger | of ordered products, total amount of cancelled |
| | | orders, date of the deadline, type of transaction, |
| | | selling price in local area, local shipment fee, |
| | | international shipment fee, domestic shipment fee, |
| | | domestic selling price, share rate of commission |
| | | fee, payment process as the buyer (ID of social |
| | | commerce business as the buyer, amount of |
| | | money to be received, actual amount received, |
| | | date that money was received, status of completed |
| | | deposit), payment process as the seller (ID of |
| | | social commerce business as the seller, amount |
| | | expected to be paid, actual amount of money paid, |
| | | payment completion date, status regarding |
| | | completion of payment), payment of international |
| | | shipment fee (ID of the shipowner, international |
| | | shipment fee (advanced payment), international |
| | | shipment fee (deferred payment, payment date, |
| | | status of payment) payment for customs (tariff, |
| | | date of payment, status of payment) domestic |
| | | shipment fee (ID of the shipowner, date of |
| | | payment, status of payment), profit amount, status |
| | | of transaction |
| T14 | International/domestic | ID of the shipowner, name of the shipowner, |
| | delivery service | nationality, classification, name of the CEO, URL, |
| | information | company address, main contact number, IP |
| | | address, person in charge, e-mail of the person in |
| | | charge, phone number of the person in charge, |
| | | bank, account number |
| T15 | International shipping | Internal coupon ID, ID of social commerce |
| | information for | business as the buyer, specific type, total product |
| | coupon | quantity, deadline, arrival date of the international |
| | | shipment, checking the amount and the cargo, ID |
| | | of the shipowner, number of the shipment, |
| | | international shipment fee (including the |
| | | insurance), date of the shipment, expected arrival |
| | | date in the domestic area, arrival date in the |
| | | domestic area, checking the amount and the cargo |
| T16 | Customs information | Internal coupon ID, ID of social commerce |
| | for coupon | business as the buyer, specific type, total product |
| | | quantity, customs application date, expected date |
| | | for custom clearance, customs fee, custom |
| | | clearance date, status of custom clearance |
| T17 | Domestic shipping | Internal coupon ID, ID of social commerce |
| | information for | business as the buyer, total product quantity, ID of |
| | coupon | the shipowner, starting date of the domestic |
| | | shipment, amount of completed delivery, |
| | | problematic amount in domestic shipment |
| T18 | Coupon evaluation | Internal coupon ID, minimum amount of sales, |
| | information | sales amount, number of sales, number of |
| | | cancelled sales, number of companies that sold |
| | | the product, number of refunds, popularity |
| T19 | Social commerce | ID of social commerce business, transaction date/ |
| | business related | year, role of the seller (number of transaction |
| | evaluation | related suggestions, total amount of transaction |
| | information | sales, number of refunds), role of the buyer |
| | | (number of transaction approval, number of |
| | | refused transaction, total number of orders, total |
| | | number of cancelled order, total of transaction |
| | | payment, number of overdue payment, total |
| | | assessment) |
| T20 | Various code related | Code classification, code ID, code number, date |
| | information | when the code was created |

Computer used for intermediate transaction 100 is explained as below in more detail.

Multiple computers used for social commerce business as the buyer 200 is the computer system operated by social commerce business that sells discount coupon of the product of the partner company bound by contract wherein it sells discount coupon of other social commerce business partner company, and not just the discount coupon of their partner company. In order to achieve this, request for approval is sent to computer used for intermediate transaction 100 in order for their information to be registered for intermediate transaction.

Then, multiple computers used for social commerce business as the buyer 200 downloads the intermediary solution which includes transaction message for mutual intermediate transaction, API module needed for message transmission, program design manual and instruction manual from the portal server of computer used for intermediate transaction 100 to be applied to their respective system in order to prepare for the intermediate transaction system.

Afterwards, computer used for intermediate transaction 100 receives coupon information and conditions of the transaction from computer used for social commerce business as the seller 300 to evaluate business value and profitability wherein information on whether coupon would be up for transaction is sent to computer used for intermediate transaction 100 where coupon information file will be received once the transaction is established. If the coupon is from social commerce business in overseas, coupon information file that had been translated for local use will be provided for domestic customers.

Moreover, multiple computers used for social commerce business as the buyer 200 undertake the task of preparation for selling the coupon in the web page by processing the coupon information file accordingly.

When multiple computers used for social commerce business as the buyer 200 receive cancellation of the purchased coupon or order cancellation request, it checks the deadline of the corresponding coupon as sent by the computer used for intermediate transaction 100. When the coupon hasn't reached the deadline, order or order cancellation process is carried out wherein order or order cancellation process is sent to computer used for intermediate transaction 100 with the message format that had been previously agreed upon with computer used for intermediate transaction 100 to carry out the order or order cancellation.

When the deadline draws near, multiple computers used for social commerce business as the buyer 200 receives the transaction deadline information of the corresponding coupon from computer used for intermediate transaction 100 to carry out the internal task related to the deadline. When computer used for intermediate transaction 100 sends the message about entire transaction of the coupon being cancelled as it did not reach minimum sales amount specified by condition of the transaction, entire transaction with computer used for social commerce business as the buyer 200 is cancelled and customers who ordered the coupon are refunded and also provided with information about refunds and cancelling the order during the process of terminating coupon related transaction.

Reversely, when minimum sales amount is exceeded and the computer used for intermediate transaction 100 sends the message that transaction had been established, transaction history of the corresponding coupon is sent to the computer used for intermediate transaction 100 wherein consistency of transaction history with computer used for intermediate transaction 100 is checked.

After the checking process, summary of coupon transaction history and request for transaction payment is sent by the computer used for intermediate transaction 100 wherein request to proceed with the money transfer according to the conditions of the transaction is sent to computer used in financial institutions 400 after checking the consistency to end the coupon related transaction between social commerce businesses.

When coupon transaction is between domestic social commerce businesses, delivering the ordered product to the customers is handled by the partner company in contract with the social commerce business as the buyer. When coupon related transaction is carried out with international social commerce business, international delivery and domestic delivery is handled by intermediary company. In case where delivery is not possible due to change of address and other circumstances, computer used for social commerce business as the buyer 200 receives information that delivery was not made possible from computer used for intermediate transaction 100 wherein domestic delivery company delivers the product that had been ordered to the company to wait for request by the customer in regards to delivery. When there is a request for the delivery from the customer, ordered product is sent out to the customer and the transaction ends.

Computer used for social commerce business as the seller 300 is explained as below in more detail. Computer used for social commerce business as the seller 300 corresponds to social commerce business as the buyer wherein it refers to computer system operated by social commerce business that sells discount coupons for products provided by the partner company to registered customers. In order to sell the discount coupon for product of the partner company to customers registered in other social commerce business in overseas, request for approval is sent to computer used for intermediate transaction 100 in order for their information to be registered for intermediate transaction.

Computer used for social commerce business as the seller 300 downloads intermediary solution to prepare for system related tasks from the web portal of computer used for intermediate transaction 100 in the same manner as computer used for social commerce business as the buyer 200.

Afterwards, computer used for social commerce business as the seller 300 places the request to computer used for intermediate transaction 100 in order to reserve the coupons that it intends to sell wherein computer used for intermediate transaction 100 sends out the request for coupon information and conditions of the transaction when reserved date approaches. After sending confirmed coupon related information and condition of the transaction, preparation tasks for transaction process between social commerce businesses take place after receiving transaction approval related information for the corresponding coupon from the computer used for intermediate transaction 100.

When there are no social commerce businesses that approved the transaction of the corresponding coupon, transaction for the said coupon is terminated.

Afterwards, computer used for social commerce business as the seller 300 receives the message for coupon order or coupon order cancellation from the computer used for intermediate transaction 100 wherein order or order cancellation task is carried out when corresponding coupon has not yet expired.

Moreover, when the deadline for corresponding coupon has been reached, computer used for social commerce business as the seller 300 sends the information regarding the deadline to computer used for intermediate transaction 100 to end the transaction of corresponding coupon.

When computer used for intermediate transaction 100 sends the message about entire transaction of the coupon being cancelled as it did not reach minimum sales amount specified by condition of the transaction, entire transaction with computer used for social commerce business as the seller 300 is cancelled.

Reversely, when minimum sales amount is exceeded and the computer used for intermediate transaction 100 sends the message that transaction had been established, transaction history of the corresponding coupon is sent to the computer used for intermediate transaction 100 wherein consistency of transaction history with computer used for intermediate transaction 100 is checked.

After the checking process, summary of coupon transaction history and request for transaction payment is sent by the computer used for intermediate transaction 100 wherein request to proceed with the money transfer according to the conditions of the transaction is sent to computer used in financial institutions 400 after checking the consistency to end the coupon related transaction between social commerce businesses. After this, 300 proceeds with the tasks regarding transaction related to the partner company.

Computer used in financial institutions 400 is the computer system operated by financial institution that handles fund deposit and fund checking related services in relation to intermediate transaction between social commerce businesses wherein it carries out the task of transferring the funds after receiving the instructions regarding fund transfer from computer used for social commerce business as the buyer 200 and computer used for intermediate transaction 100 as well as relaying the result of the fund transfer to computer used for social commerce business as the buyer 200 and computer used for intermediate transaction 100 in following cases wherein multiple computers used for social commerce business as the buyer 200 make the deposit to the account of the computer used for intermediate transaction 100 except for small amount of money from coupon payments that had been sold according to conditions of the transaction, computer used for intermediate transaction 100 making the deposit to the account of computer used for social commerce business as the seller 300 except for small amount of money according to the conditions of the transaction, computer used for intermediate transaction 100 transferring the money for international shipping fee to computer used by international delivery services company 500, transferring the money for customs tax and custom clearance fee to the account of electronic customs procedure computer 600 and transferring the money for domestic delivery fee to the account of computer used by domestic delivery services company 700.

Computer used by international delivery services company 500 is the computer system operated by international delivery company that delivers the product as requested by computer used for intermediate transaction 100 for transactions between international social commerce businesses wherein it receives the information about the product and shipping fee from computer used for intermediate transaction 100, calculates and evaluates necessary information such as shipment fee and sends the information about the final shipment which also includes the information on shipment fee to the computer used for intermediate transaction 100 to receive the shipment fee wherein it proceeds with the international shipment process according to the shipment order and sends the product arrival related information to the computer used for intermediate transaction 100 when product arrives to the corresponding country and also proceeds with necessary procedures after the task had been completed.

Electronic customs procedure computer 600 is the computer system operated by Customs Bureau that performs tasks related to the customs and sets the rate of customs tax as well as receiving the customs tax wherein it receives product information needed for customs related tasks from the computer used for intermediate transaction 100 to set the customs tax and when it receives the customs tax from the computer used for intermediate transaction 100, it sends the result of the custom clearance to computer used for intermediate transaction 100 when corresponding transaction is between international social commerce businesses.

Computer used by domestic delivery services company 700 is the computer system operated by domestic delivery company that delivers the product as requested by computer used for intermediate transaction 100 for transactions between domestic social commerce businesses wherein it receives the information about the product and shipping fee from computer used for intermediate transaction 100, calculates and evaluates necessary information such as shipment fee and sends the information about the final shipment which also includes the information on shipment fee to the computer used for intermediate transaction 100 to receive the shipment fee wherein it proceeds with domestic shipment process according to the shipment order and sends the product arrival related information to the computer used for intermediate transaction 100. When delivery procedure cannot be completed due to circumstances such as unclear recipient address, product is then delivered to a place that computer used for social commerce business as the buyer 200 has designated.

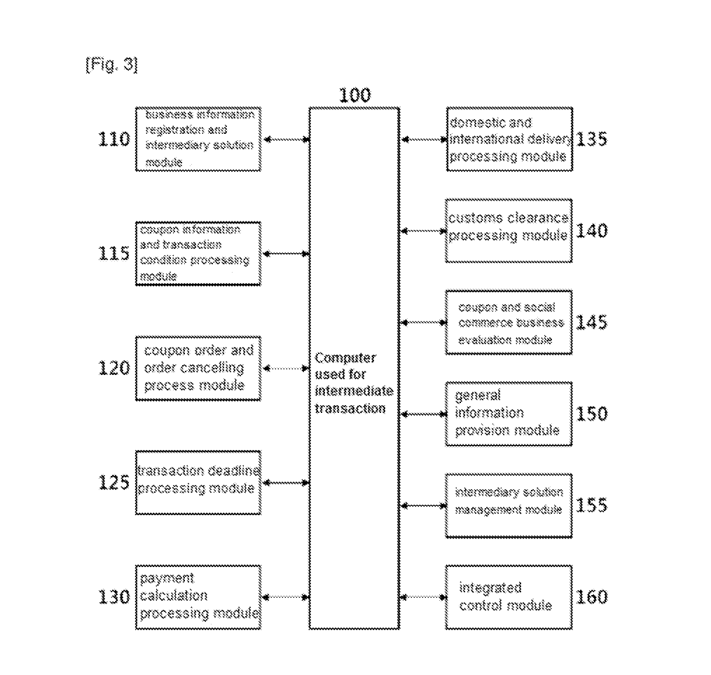

FIG. 3 is a block diagram illustrating specific details of internal configuration of computer for intermediate transaction in FIG. 1 according to the embodiment of present invention.

As illustrated, computer used for intermediate transaction 100 comprises of business information registration and intermediary solution module 110, coupon information and transaction condition processing module 115, coupon order and order cancelling process module 120, transaction deadline processing module 125, payment calculation processing module 130, domestic and international delivery processing module 135, customs clearance processing module 140, coupon and social commerce business evaluation module 145, general information provision module 150, intermediary solution management module 155, and integrated control module 160.

Business information registration and intermediary solution module 110 carries out the task of registration approval according to the satisfied condition for registration after receiving the request for intermediate transaction registration from the social commerce businesses as the buyer and social commerce businesses as the seller that wish to have mutual intermediate transaction between social commerce businesses wherein it helps social commerce business computer prepare for intermediate transaction by downloading transaction message needed for mutual intermediate transaction, standard API module for transmission and reception interface as well as program design manual and instruction manual.

Coupon information and transaction condition processing module 115 receives and registers the request for coupon sales reservation for coupon that computer used for social commerce business as the seller 300 intends to sell. Before the sales reservation date, it requests conditions related to coupon information and transaction from computer used for social commerce business as the seller 300. If coupon transaction is between international social commerce businesses, international shipment fee, customs tax and domestic delivery fee is calculated to generate the final transaction deal to be sent to computer used for social commerce business as the buyer 200 as it prepares for the transaction after receiving the confirmation regarding the conditions of the transaction. Coupon information file is processed for domestic customers to be sent to multiple computers used for social commerce business as the buyer 200. Then, coupon information and transaction condition processing module 115 may include social commerce business buyer selecting module that can select computer used for social commerce business as the buyer 200 in case computer used for social commerce business as the seller 300 wishes to sell coupons as intermediary in specific countries and specific areas.

To provide an example in reference to Table 1, coupon information and transaction condition processing module 115 reads the table with basic information of social commerce businesses T1 in consecutive in order to compare it to the list of countries and areas that social commerce business is located based on the information on countries and areas that social commerce business wishes to sell the coupon at in the coupon sales reservation table T2 where computer used for social commerce business as the seller 300 has stored the sales reservation information. When social commerce business wishes to sell to overseas, it is classified as international trade wherein all social commerce businesses registered in the table with basic information of social commerce businesses T1 is selected as social commerce business as the buyer. When social commerce business wishes to sell in specific country and specific area, social commerce business in specific area is selected as social commerce business as the buyer. When social commerce business wishes to sell to specific country and to sell in all areas, social commerce business that belong to specific country is selected as social commerce business as the buyer. Selected social commerce business as the buyer should satisfy the fixed conditions of social commerce business related evaluation information table T19 as defined by computer used for intermediate transaction 100.

Coupon order and order cancelling process module 120 receives the message regarding order or order cancellation of the coupon from multiple computers used for social commerce business as the buyer 200 to evaluate if it is possible to place the order or cancel the order after checking the status of transaction deadline and conditions of the transaction. When it is determined that order or order cancellation is possible, information regarding order or order cancellation is generated wherein message format that had been agreed upon with computer used for social commerce business as the seller 300 is used to send the message for order or order cancellation.

Transaction deadline processing module 125 receives the coupon deadline information from computer used for social commerce business as the seller 300 to end the coupon related transaction. Number of coupon transactions is checked in order to determine if it exceeds the minimum number of sales. When the minimum number of sales exceeded, transaction had been established and when it falls short, it is considered as failed transaction.

In case of failed transaction, buyer and social commerce business computer as the seller requests the cancellation of the entire coupon transaction wherein the task of cancelling the entire transaction regarding the corresponding coupon within the computer used for intermediate transaction 100 is carried out.

Payment calculation processing module 130 compares the transaction history provided by social commerce businesses that participated in coupon transaction when transaction had been established with the transaction history of the computer used for intermediate transaction 100.

When the result is consistent, information needed for payment related calculation between social commerce businesses is generated wherein payment deposit and payment process for the coupon is made out to computer used for social commerce business as the buyer 200 wherein task related to notice of payment and providing payment to computer used for social commerce business as the seller 300 is carried out.

When coupon transaction is between international social commerce businesses, responsibility of delivering the product to customer in the domestic area falls to the intermediary company. In order to process this task, domestic and international delivery processing module 135 receives the product from the designated area in overseas through the partner company of social commerce business as the seller wherein the consistency between the product statement and coupon transaction statement is checked wherein product information and information on payment is provided to computer used by international delivery services company 500 for confirmation when information on statements are found to be consistent. Afterwards, shipment order is given out to computer used by international delivery services company 500 and confirmed international shipment fee is paid through computer used in financial institutions 400. When the product arrives to the country, consistency between product statement and coupon transaction statement is checked wherein payment is given to computer used by international delivery services company 500 and due process after the delivery is carried out.

Domestic and international delivery processing module 135 provides shipment payment and product related information wherein the product had been cleared by the customs to computer used by domestic delivery services company 700 for confirmation in order to deliver the products that arrived to the country to the customers. After the confirmation, delivery order is given and confirmed domestic delivery fee is paid through computer used in financial institutions 400 wherein information regarding completion of delivery is provided to computer used for social commerce business as the buyer 200 when domestic delivery process had been completed. In case domestic delivery cannot be completed, delivery failure information is sent to computer used for social commerce business as the buyer 200 wherein order is given to computer used by domestic delivery services company 700 to send the product to social commerce business as the buyer.

Customs clearance processing module 140 generates information such as tax rate of the product associated with the coupon and other information needed for customs clearance when the coupon transaction is between international social commerce businesses wherein customs message is sent out by connecting to electronic customs procedure computer 600 and customs tax is paid by connecting to computer used in financial institutions 400 to check the status of custom clearance where due procedure is carried out after the customs clearance had been completed.

It is a clear fact that the modules such as payment calculation processing module 130, domestic and international delivery processing module 135, and customs clearance processing module 140 all connect to computer used in financial institutions 400 in order to process the task regarding deposit, payment, payment for shipment and tax payment.

Coupon and social commerce business evaluation module 145 evaluates the popularity of the coupon and also evaluates social commercial businesses as the buyer and seller that participated after the coupon transaction has ended. Then the evaluation regarding popularity of the coupon is calculated according to total amount of sales, sales quantity, number of cancellation after the order, and the number of social commerce businesses as the seller wherein computer used for intermediate transaction 100 evaluates according to its fixed evaluation standard. Evaluation of social commerce business as the buyer is based on number of transaction approval issued to social commerce businesses that suggested the transaction per cycle, number of rejected transactions, number of orders, number of order cancellations, total amount of coupon sales payment and number of deferred payments to intermediate transaction company are calculated and evaluated in accordance with the evaluation standard of computer used for intermediate transaction 100. After this, coupon and social commerce business evaluation module 145 sends the evaluation of coupon popularity and the result of evaluation regarding social commerce business as the buyer and the seller to the computer of social commerce business as the buyer and the seller.

General information provision module 150 provides various tables with the purpose as seen on Table 2 in order for all the participating businesses to view various types of information during the coupon related transaction between social commerce businesses wherein general information can be viewed on web portal of computer used for intermediate transaction 100.

TABLE 2

| Table Name | |
|---|---|
| According to | |
| its Purpose | Important Items of the Table |
| Basic | Social commerce business ID, name of the |
| information | social commerce business, company address, |
| of social | contact number of the person in charge, |
| commerce | country, area, status regarding stopped |
| business | transaction |
| Integrated | Coupon information, information on condition |
| coupon | regarding coupon transaction, type of coupon |
| transaction | transaction approval for social commerce |
| information | business as the buyer |
| Integrated | Information on status of the order by cases, |
| coupon | information on order cancellation, amount of |
| order and order | current coupon order, amount of current order |
| cancellation | cancellation, number of coupons available, amount |
| information | of time left to sell, status regarding the deadline |
| General | Information on status of coupon deadline, expected |
| information | deadline for the coupon, number of order placed on |
| on coupon | each social commerce businesses as the buyer after |
| transaction | the deadline, amount of money expected to be paid |
| deadline | to each social commerce businesses as the buyer |
| | after the deadline |
| Information on | Status of international delivery of the coupon, |
| status of | information on custom clearance of the coupon, |
| coupon | information on the status regarding domestic |
| international | delivery for each product |
| and domestic | |
| delivery | |
| Information | Status of payment provided to social commerce |
| on coupon | businesses as the buyer, status of payment made by |
| payment/ | social commerce businesses as the seller, status of |
| deposit | payment to international shipment company, status |
| status | of payment regarding customs tax, status of payment |
| | to domestic delivery company |
| General | Status regarding amount of profit of intermediary |
| information | company between social commerce businesses, ranking |
| on the result | list of popular coupons, rate of transaction |
| of coupon | approval according to coupons, ranking list of |
| transaction | favorite coupons according to types |

Intermediary solution management module 155 manages transaction message format needed for intermediate transaction between computers of social commerce businesses, various API modules needed for message transmission between the computers, program design manual to apply them to computers of social commerce businesses and instruction manual needed for overall operation.

It also carries out the task of developing, testing and managing intermediary solution by creating or modifying the transaction message format, corresponding API module, program design manual and instruction manual in order to maintain the solution in optimal condition when new services, functions or technology is applied during intermediate transaction between social commerce businesses.

As computer used for intermediate transaction 100 is connected to computer used for social commerce business as the buyer 200, computer used for social commerce business as the seller 300, computer used in financial institutions 400, computer used by international delivery services company 500, electronic customs procedure computer 600, computer used by domestic delivery services company 700 through internet, virtual private network, private line and other communications network, it carries out the task of monitoring the status of the network, real-time monitoring to prevent error of the servers, controls the transmission of messages between businesses, monitoring the various processes needed for intermediate transaction and their current status, regular data deletion and backup process for optimization of various data that are created and stored during transaction.

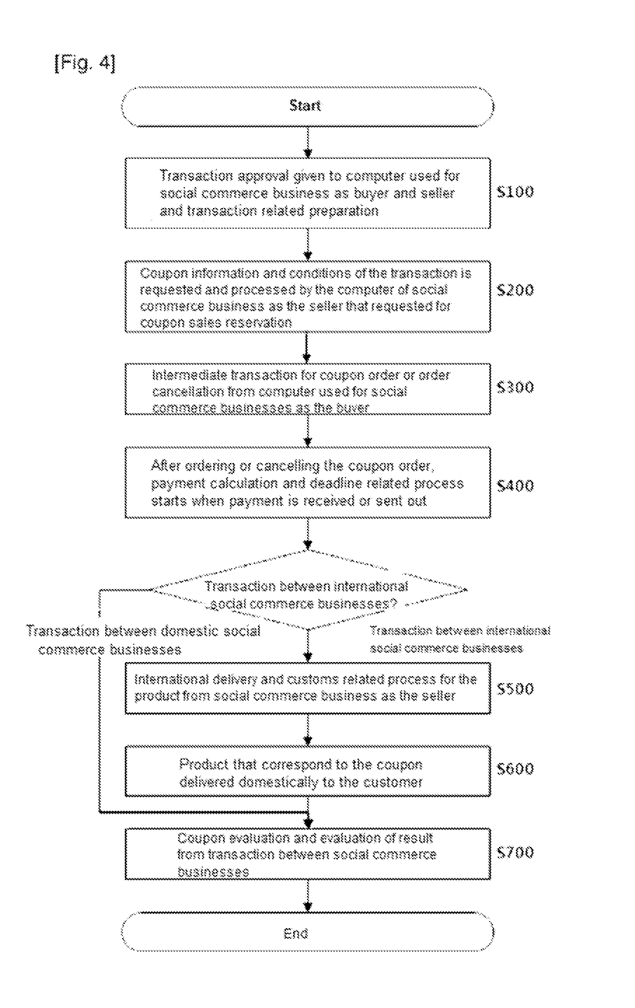

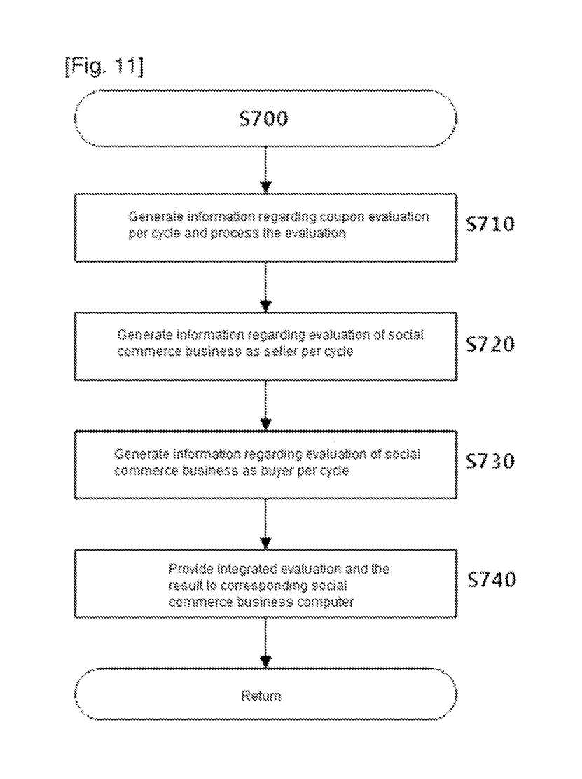

FIG. 4 and FIG. 11 is a flowchart illustrating the outline of intermediate transaction between multiple social commerce businesses in details according to the embodiment of present invention.

FIG. 4 is an outline illustrating the flow of intermediate transaction between multiple social commerce businesses.

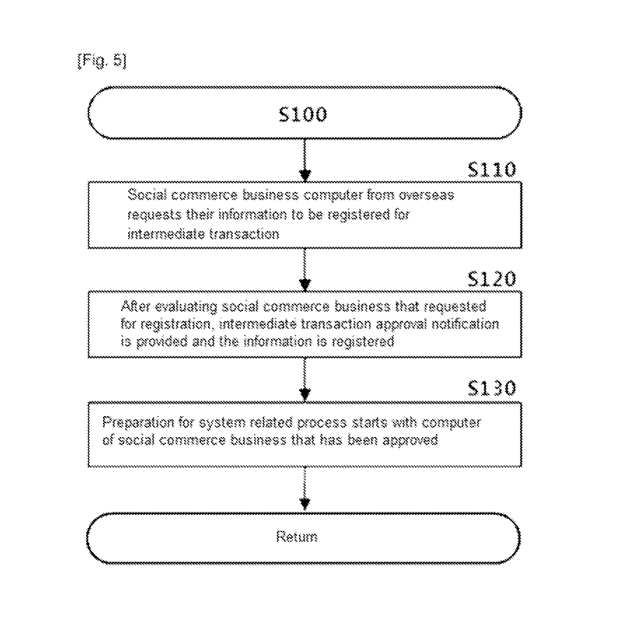

FIG. 5 is illustrates the process wherein computer used for social commerce business requests the computer for intermediate transaction 100 to perform intermediary transaction task in preparation for intermediate transaction and important aspects had been explained in the function of business information registration and intermediary solution module 110.

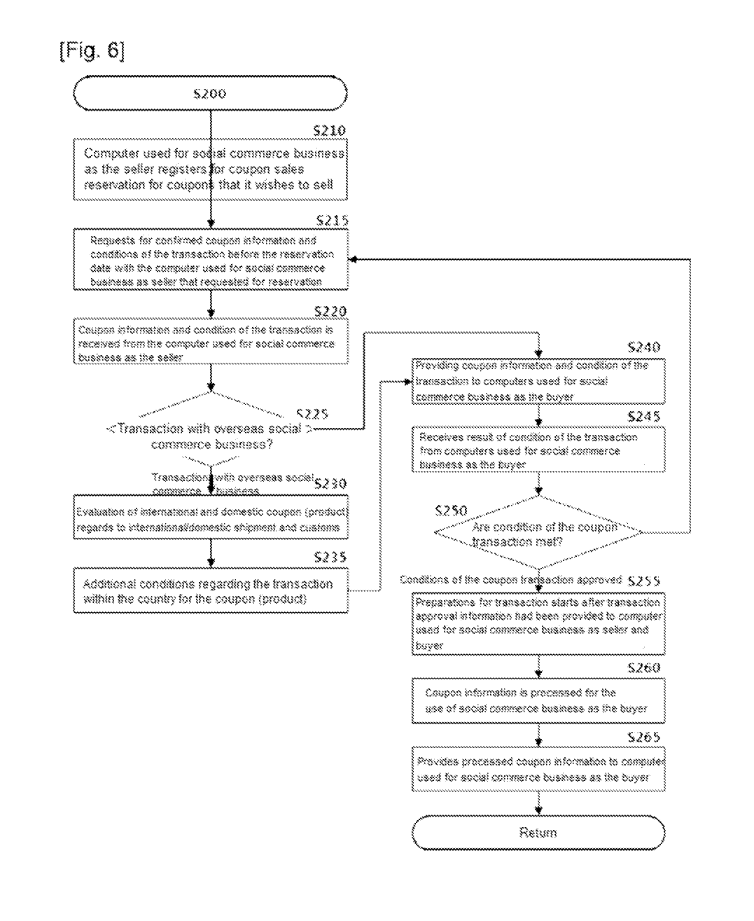

FIG. 6 illustrates the process wherein computer used for social commerce business requests the computer for intermediate transaction to perform coupon information and transaction requirement process and important aspects had been explained in the function of coupon information and transaction condition processing module 115.

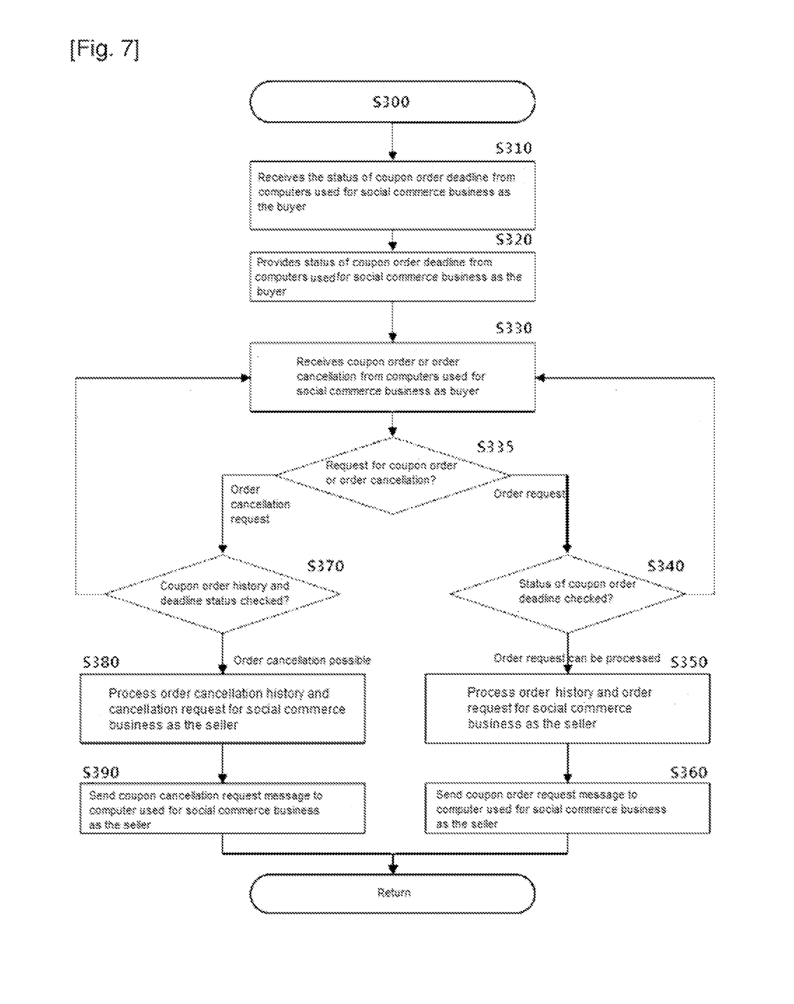

FIG. 7 illustrates the process of coupon being ordered and coupon being cancelled and important aspects had been explained in the function of coupon order and order cancelling process module 120.

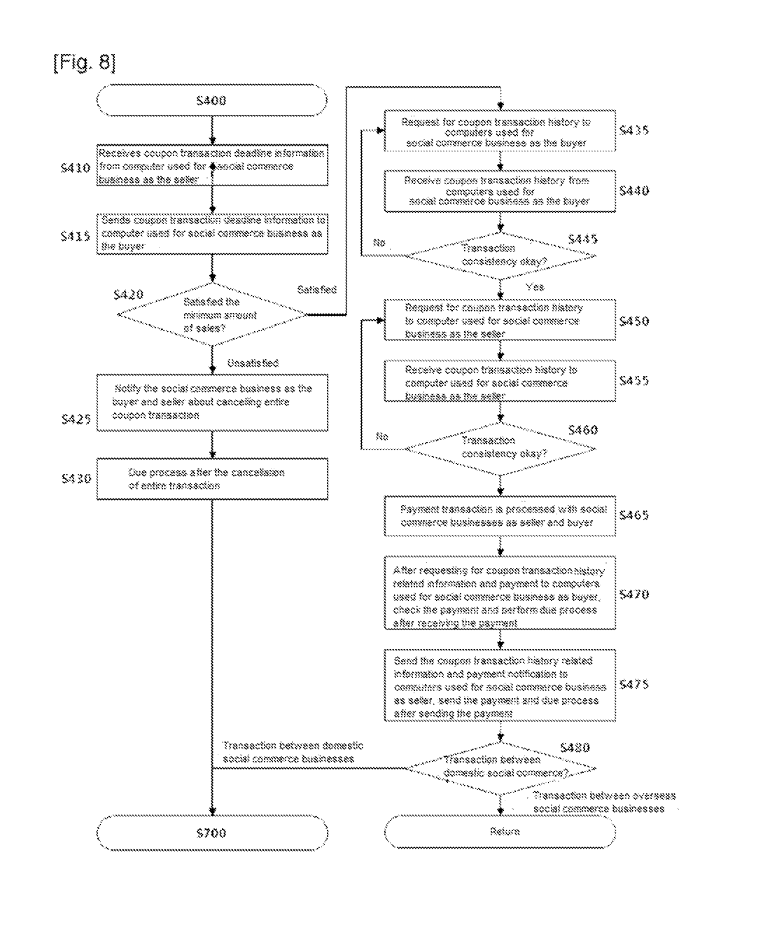

FIG. 8 illustrates the process of payment being calculated after the transaction had been completed and important aspects had been explained in the function of transaction deadline processing module 125.

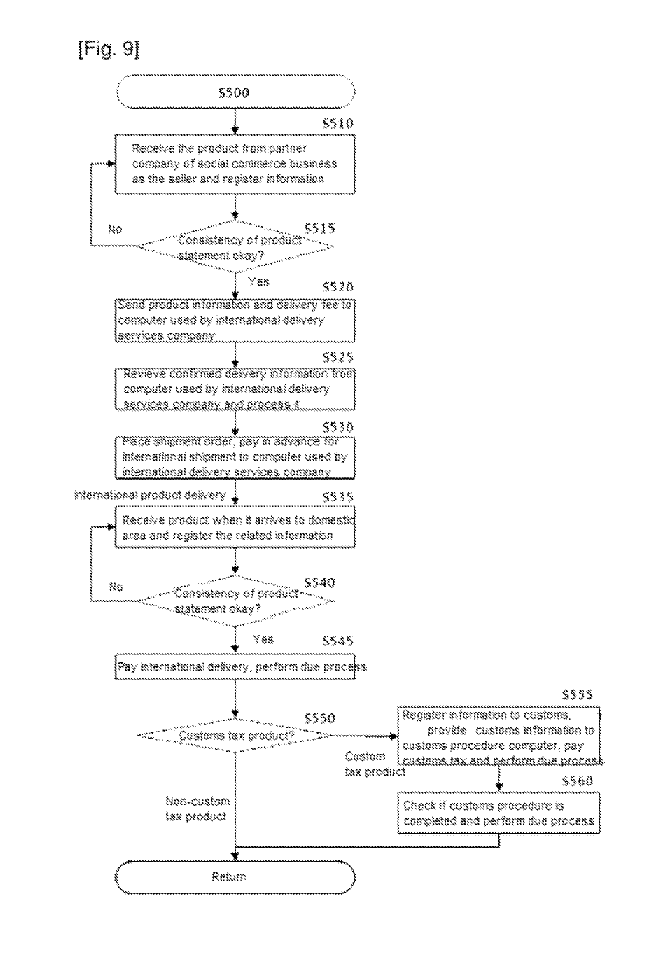

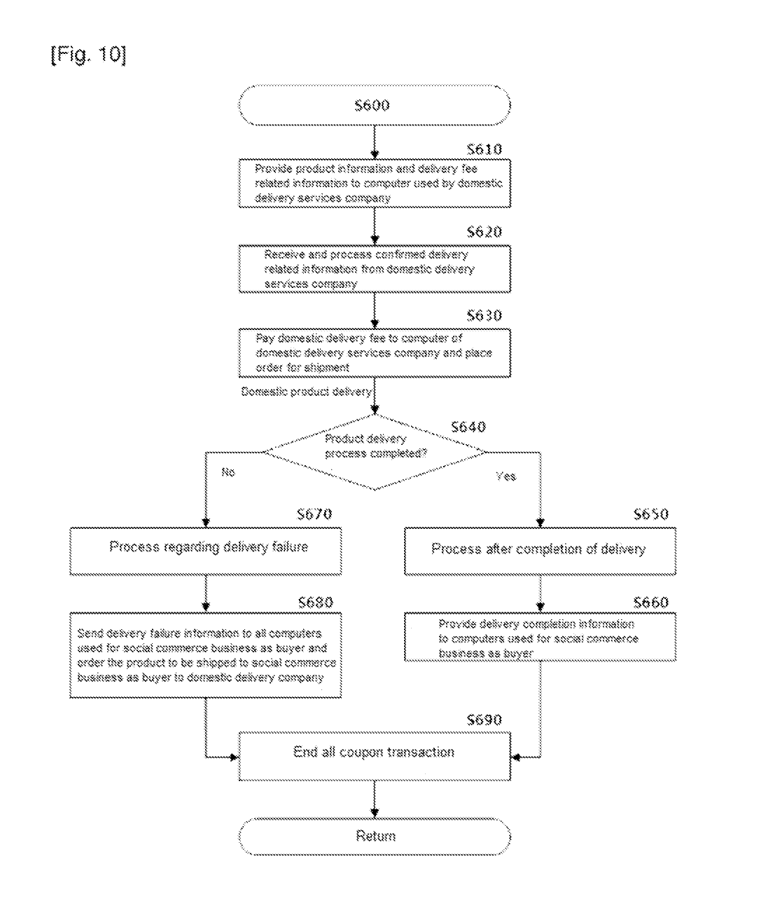

FIG. 9 illustrates the process of international shipping process and custom clearance process during the transaction between international social commerce businesses and FIG. 10 illustrates the process of product being processed for domestic deliver service after it had been internationally shipped or cleared from the customs during the transaction between international social commerce businesses important aspects had been explained in the function of domestic and international delivery processing module 135 and customs clearance processing module 140.

FIG. 11 illustrates the process of providing the information regarding customer satisfaction of social commerce business and popularity of the coupon as result of the transaction and important aspects had been explained in the function of coupon and social commerce business evaluation module 145.

FIG. 12 illustrates the flow of payment process. Domestic customer A pays computer used for social commerce business as the buyer 200 A for price of the product, social commerce business fee A, transaction intermediary fee, social commerce business fee B, delivery fee for local area of overseas, international delivery fee and customs as well as domestic delivery fee. Computer used for social commerce business as the buyer 200 A pays computer used for intermediate transaction 100 the amount that domestic customer A paid excluding the social commerce business fee A.

Computer used for intermediate transaction 100 pays international delivery fee, customs and domestic delivery fee to computer used by international delivery services company 500, electronic customs procedure computer 600 and computer used by domestic delivery services company 700.

To the computer used for social commerce business as the seller 300 B, only the price of good and social commerce business fee for overseas and local delivery fee is paid from the payment provided by computer used for social commerce business as the buyer 200 A.

Computer used for social commerce business as the seller 300 B pays the price of good and delivery fee of local area in overseas to the partner company of social commerce business wherein the partner company pays the delivery company in the local area of the overseas company to conclude the payment process of intermediate transaction between multiple social commerce businesses.

### EXPLANATION OF THE TERMS

100: Computer used for intermediate transaction
200: Computer used for social commerce business as the buyer
300: Computer used for social commerce business as the seller
400: Computer used in financial institutions
500: Computer used by international delivery services company
600: Electronic customs procedure computer
700: Computer used by domestic delivery services company
110: Business information registration and intermediary solution module
115: Coupon information and transaction condition processing module
120: Coupon order and order cancelling process module
125: Transaction deadline processing module
130: Payment calculation processing module
135: Domestic and international delivery processing module
140: Customs clearance processing module
145: Coupon and social commerce business evaluation module
150: General information provision module
155: Intermediary solution management module
160: Integrated control module

1. Intermediate transaction system for multiple social commerce businesses wherein the system comprises of:
an intermediate transaction computer that mediates coupon transaction between multiple social commerce businesses;
a computer used for social commerce business as the buyer connected to the computer used for intermediate transaction that orders or cancels the coupon order according to the condition of the transaction after requesting for intermediate transaction registration;
a computer used for social commerce business as the seller connected to the computer used for intermediate transaction that proposes coupon sales reservation related information and conditions for transaction after requesting for intermediate transaction registration wherein it also carries out the task of coupon order and order cancellation;
a computer used in financial institutions connected to the computer used for intermediate transaction that processes transaction payment, delivery fee, customs tax and fee between participating businesses by transferring the funds;
a computer used by international delivery services company connected to the computer used for intermediate transaction that processes the international shipment of the product that corresponds to the coupon when the coupon transaction is between international social commerce businesses;
an electronic customs procedure computer connected to the computer used for intermediate transaction that collects the taxes for the products that corresponds to the coupon when the product that had been delivered from overseas need to pay the customs tax; and
computer of domestic delivery business connected to intermediate transaction computer in order to deliver the internationally shipped product in the domestic area.

2. Intermediate transaction system for multiple social commerce businesses of claim 1 wherein the computer used for intermediate transaction comprises:
a business information registration and intermediary solution module that grants approval upon receiving the request for registration for intermediate transaction from the computer of social commerce business to provide intermediary solution to approved social commerce business computer;
a coupon information and transaction condition processing module that receives coupon sales reservation from computer of social commerce business as the seller wherein it confirms and processes the coupon information and conditions of the transaction that it received in order to send it to computer of social commerce business as the buyer wherein it prepares for transaction after receiving the transaction approval;
a coupon order and order cancelling process module that receives coupon order or order cancellation from computer used for social commerce business as the buyer to evaluate the possibility of transaction wherein message for order or order cancellation is sent to the computer used for social commerce business as the buyer when it is possible for transaction to take place wherein transaction failure message is sent to the computer used for social commerce business as the buyer when the transaction is not possible;
a transaction deadline processing module that evaluates whether the transaction was established at the time of the deadline according to the conditions of the transaction in order to check the consistency with the social commerce business when the transaction was established wherein notification regarding cancellation of entire coupon transaction is sent to commerce business as the buyer and the seller;
a payment calculation processing module that sends the payment notification and the payment to computer used for social commerce business as the seller when transaction was established and transaction information is found to be consistent after generating the information for payment related calculation;
a domestic and international delivery processing module that generates shipment information to deliver the product corresponding to the coupon to overseas and domestic area when the coupon transaction is between international commerce businesses wherein it connects to computer used by international and domestic delivery services company carry out the payment related task and placing delivery order;
a customs clearance processing module that carries out the task of paying customs clearance and customs tax by generating customs related information and connecting to electronic customs procedure computer when the product delivered through international delivery needs to pay customs tax;
a coupon and social commerce business evaluation module that evaluates the satisfaction rate of computer used for social commerce business as the buyer and seller as well as popularity of the coupon by analyzing the transaction history when coupon transaction ends;
a general information provision module that allows businesses participating in coupon intermediate transaction to view general information that are needed during intermediate transaction through the web portal;
a intermediary solution management module that maintains and manages transaction message, API module, program design and instruction manual that computers of social commerce businesses need during intermediate transaction; and
a integrated control module that checks the status of network connecting the computer used for intermediate transaction and computers used by businesses, controls message transmission, monitors the status regarding the operation of modules and optimizing the generated data.

3. Intermediate transaction system for multiple social commerce businesses of claim 2 wherein intermediary solution comprises:
a transaction message format transmitted between computer used for intermediate transaction and computer of social commerce businesses;
an API module which provides the necessary interface for message transmission between computer used for intermediate transaction and computer of social commerce businesses;
a program design manual necessary in developing the program to be installed in social commerce business computer for intermediate transaction; and
an instruction manual.

4. Intermediate transaction system for multiple social commerce businesses of claim 1 wherein computer used for intermediate transaction comprises:
a external link server with the responsibility of interface and processing communication with computer used for social commerce business as the buyer, computer used in financial institutions, computer used by international delivery services company, electronic customs procedure computer and the computer used by domestic delivery services company;
a work process server with the responsibility of processing internal work process of the computer used for intermediate transaction;
a portal server that allows multiple social commerce businesses to download intermediate transaction request, information view and intermediary solution; and
an intermediary solution management server for maintaining and managing the intermediary solution.

5. Intermediate transaction system for multiple social commerce businesses of claim 1 wherein computer used for intermediate transaction further comprises social commerce business buyer selecting module which selects computer used for social commerce business as the buyer in case computer used for social commerce business as the seller wishes to sell coupons as intermediary in specific countries and specific areas.

6. Intermediate transaction system for multiple social commerce businesses of claim 2 wherein information processing provided by computer used for social commerce business as the seller is defined as coupon transaction being processed during transaction between international social commerce wherein international delivery fee, customs tax, and domestic delivery fee is calculated to be added to conditions of the transaction wherein coupon information is translated for domestic use to be provided.

7. Intermediate transaction system for multiple social commerce businesses of claim 2 wherein coupon popularity evaluation is based on fixed evaluation standard based on total amount of sales, sales quantity, number of cancellation after the order, and the number of social commerce businesses as the buyer who sold the coupon.

8. Intermediate transaction system for multiple social commerce businesses of claim 2 wherein satisfaction evaluation for social commerce business as the buyer and seller is based on fixed evaluation standard wherein for social commerce business as the seller, it is based on number of coupon transaction suggestion per cycle based on coupon sales amount and in case of social commercial business as the buyer, it is based on number of transaction approval issued to social commerce businesses that suggested the transaction per cycle, number of rejected transactions, number of orders, number of order cancellations, total amount of coupon sales payment and number of deferred payments to intermediate transaction company.

9. Intermediate transaction system for multiple social commerce businesses of claim 2 wherein general information that businesses participating in coupon intermediate transaction need comprises:
basic information of social commerce businesses including name of the participating social commerce businesses and the country information;
general information on coupon transaction which includes coupon information and conditions of the transaction;
general order and order cancel information which includes status of order and order cancellation by cases, number of coupons left, time left for coupon sales and the status of deadline;
general information on transaction deadline which includes status of coupon transaction at the deadline and amount that corresponding social commerce business has to pay or receive;
information on status of domestic and international delivery which includes delivery status of the product corresponding to the product and customs tax related information;
information on deposit and payment status which includes deposit, payment, payment of the fee between businesses; and
information on result of the transaction which includes amount of profit of intermediary transaction company, ranking list of popular coupons, rate of transaction approval according to coupons, ranking list of favorite coupons according to types.

10. Intermediate transaction system for multiple social commerce businesses of claim 1 wherein computer used for social commerce business as the seller requests for intermediate solution registration through the web portal provided by computer used for intermediate transaction wherein it receives intermediary solution needed for intermediate transaction to make it possible for systematic transaction wherein it request coupon sales reservation with computer used for intermediate transaction and provides coupon information and conditions for transaction before the reservation date, process the coupon order or order cancellation sent from computer used for intermediate transaction, process the deadline at the time of the deadline with computer used for intermediate transaction and process the payment deposit related tasks by computer used in financial institution and computer used for intermediate transaction.

11. Intermediate transaction system for multiple social commerce businesses of claim 1 wherein computer used for social commerce business as the buyer requests for intermediate solution registration through the web portal provided by computer used for intermediate transaction wherein it receives intermediary solution needed for intermediate transaction to make it possible for systematic transaction wherein it receives coupon information and conditions for transaction to send out confirmation and internally processes the order or order cancellation from the customer wherein coupon order or order cancellation is placed with computer used for intermediate transaction and processes the deadline at the time of the deadline with computer used for intermediate transaction and process the payment related tasks by computer used in financial institution and computer used for intermediate transaction.

12. Intermediate transaction method for multiple social commerce businesses wherein the method comprises:
stage wherein computer used for social commerce business as the seller requests for intermediate transaction registration to computer used for intermediate transaction wherein coupon sales reservation is placed and coupon information and conditions of the transaction is provided;
stage wherein computer used for social commerce business as the buyer connects to the computer used for intermediate transaction to request for intermediate transaction registration and proceeds with coupon order or order cancellation according to the conditions of the transaction;
stage wherein computer used for social commerce business as the seller processer the coupon order and order cancellation that are sent out;
stage wherein computer used in financial institutions processes the transfer of transaction payment, delivery fee, customs tax and commission fee;
stage wherein computer of international delivery company connects to the computer used for intermediate transaction in order to process the task regarding international delivery for the product that corresponds to the coupon when the coupon transaction is between international social commerce businesses;
stage wherein custom tax has to be paid for the product that has been delivered from overseas, electronic customs computer connects to computer used for intermediate transaction in order to impose customs tax to the product that corresponds to the coupon and proceeds with the customs clearance;
stage wherein computer used in domestic delivery company connects to the computer used for intermediate transaction in order to deliver the product that went through international delivery or custom clearance; and
stage wherein computer used for intermediate transaction processes the coupon transaction between domestic and international social commerce businesses.

13. Intermediate transaction method for multiple social commerce businesses of claim 12 wherein computer used for intermediate transaction handles the coupon intermediate transaction between domestic and international social commerce businesses through following stages wherein:
stage (a) wherein business information registration and intermediary solution module receives the intermediate transaction registration requests and approves the request from the social commercial business computer to provide intermediate solution to approved social commerce business computer;
stage (b) wherein coupon information and transaction condition processing module receives coupon sales reservation, coupon information and conditions of the transaction from computer used for social commerce business as the seller, confirms and processes it wherein it is sent to computer used for social commerce business as the buyer to receive the transaction approval to prepare for the transaction;
stage (c) wherein coupon order and order cancelling process module receives coupon order or order cancellation request to evaluate if it is possible for transaction wherein it sends the order or order cancellation to computer used for social commerce business as the seller when the transaction is possible and failure message is sent to computer used for social commerce business as the buyer when the transaction is impossible;
stage (d) wherein transaction deadline processing module evaluates if the transaction was established at the time of deadline according to the conditions of the transaction wherein transactional consistency is checked with social commerce business when the transaction was established wherein it notifies computer used for social commerce business as the buyer and seller regarding cancellation of the entire transaction when the transaction is not established;
stage (e) wherein payment calculation processing module generates the information regarding the payment when established transaction and transaction consistency checks out in order to request for the payment to computer used for social commerce business as the buyer and when it is confirmed that payment had been made, payment notification and the payment is made out to computer used for social commerce business as the seller;
stage (f) wherein domestic and international delivery processing module connects to computer used by international delivery services company that generates delivery related information when the coupon transaction is between international social commerce businesses in order to deliver the product corresponding to the coupon for shipment order and sending the payment for delivery;
stage (g) wherein customs clearance processing module connects to electronic customs procedure computer that generates customs related information when the internationally delivered product has to pay customs taxes to proceed with the customs and customs tax payment;
stage (h) wherein international and domestic delivery module connects to computer used by international delivery services company that generates delivery related information when the coupon transaction is between international social commerce businesses in order to deliver the product corresponding to the coupon for shipment order and sending the payment for delivery and proceeds with the due process according to the status of the delivery; and
stage (i) wherein coupon and social commerce business evaluation module analyzes the transaction history when coupon transaction ends in order to evaluate the coupon popularity and satisfaction rate of computer used for social commerce business as the buyer and seller.

14. Intermediate transaction method for multiple social commerce businesses of claim 13 wherein the stage (a) comprises:
stage wherein computer used by social commerce business connects to web portal of computer used for intermediate transaction in order to request for intermediate transaction registration;
stage wherein business information registration and intermediary solution module evaluates the condition of registration to notify the social commerce business computer of the result and decision regarding registration; and
stage wherein approved social commerce business computer downloads the intermediary solution from the intermediate transaction computer to prepare for intermediate transaction.

15. Intermediate transaction method for multiple social commerce businesses of claim 13 wherein the stage (b) comprises:
stage wherein coupon information and transaction condition processing module receives coupon sales reservation, coupon information and conditions of the transaction from computer used for social commerce business as the seller before the sales reservation date to register the confirmed coupon information and conditions of the transaction;
stage wherein international delivery charge, customs tax, domestic delivery fee are calculated to be added to conditions of the transaction when the coupon transaction is between international social commerce businesses;
stage wherein generated coupon information and conditions of the transaction is sent to computer used by social commerce business as the buyer to receive the transaction confirmation and to send the final confirmed registration information to computer used by social commerce business as the buyer and seller; and
stage wherein coupon information file provided by the seller is processed into the state that buyer wants to be sent to computer used for social commerce business as the buyer that approved the transaction.

16. Intermediate transaction method for multiple social commerce businesses of claim 13 wherein the stage (c) comprises:
stage wherein coupon order and order cancelling process module receives coupon order or order cancellation request;
stage wherein the message is coupon order message, evaluation regarding the possibility of transaction takes place wherein it sends the order or order cancellation to computer used for social commerce business as the seller when transaction is deemed possible and failure message is sent to computer used for social commerce business as the buyer when the transaction is impossible; and
stage wherein evaluation regarding the possibility of cancellation takes place when message that was received was coupon order cancellation wherein order cancellation message is sent to computer used for social commerce business as the seller and when the order cannot be cancelled, message that order cannot be cancelled is sent to computer used for social commerce business as the buyer.

17. Intermediate transaction method for multiple social commerce businesses of claim 13 wherein the stage (d) comprises:
stage wherein transaction deadline processing module receives the coupon deadline information from computer used for social commerce business as the seller to be sent to computer used for social commerce business as the buyer to end the transaction;
stage wherein it is evaluated if the amount of coupon order met the minimum sales amount of condition of the transaction;
stage wherein transaction consistency is checked when minimum sales amount had been exceeded by receiving the coupon order history from computer used for social commerce business as the buyer; and
stage wherein minimum sales amount was not reached, notification regarding cancellation of entire coupon transaction is sent to commerce business as the buyer and the seller all the transaction regarding corresponding coupon is cancelled from computer used for intermediate transaction.

18. Intermediate transaction method for multiple social commerce businesses of claim 13 wherein the stage (e) comprises:
stage wherein payment calculation processing module generates the information regarding the payment when established transaction and transaction consistency checks out, it calculates the amount that social commerce as buyer and seller should pay and receive based on the transaction history;
stage wherein request for the payment to computer used for social commerce business as the buyer and when it is confirmed that payment had been made through computer used in financial institution, due process after the payment is carried out;
stage wherein payment notification is sent to computer of social commerce business wherein payment is made in the expected date of the payment and due process after the payment is carried out;
stage wherein coupon transaction is between domestic social commerce businesses, process regarding ending the coupon transaction is carried out.

19. Intermediate transaction method for multiple social commerce businesses of claim 13 wherein the stage (f) comprises:
stage wherein domestic and international delivery processing module checks the consistency of product statement and coupon transaction statement that are written after receiving the product from partner company of the social commerce business as the seller when the coupon transaction is between international social commerce businesses;
stage wherein shipment order is given out to computer used by international delivery services company and confirmed international shipment fee is paid through computer used in financial institution when the consistency checks out; and
stage wherein the product arrives to the country and consistency between product statement and coupon transaction statement is checked wherein payment is given to computer used by international delivery services company when consistency checks out wherein due process after the delivery also takes place.

20. Intermediate transaction method for multiple social commerce businesses of claim 13 wherein the stage (g) comprises:
stage wherein customs clearance processing module generates the necessary information such as customs tax of the product that corresponds to the coupon when the product that arrived to the country needs to pay the customs tax;
stage wherein customs clearance processing module connects to electronic customs procedure computer to send the customs message; and
stage wherein customs clearance processing module connects to electronic customs procedure computer and pays the customs tax and checks that custom clearance had been completed wherein due process after custom clearance is carried out.

21. Intermediate transaction method for multiple social commerce businesses of claim 13 wherein the stage (h) comprises:
stage wherein international and domestic delivery module provides international delivery, custom cleared product information and delivery fee information to be confirmed to computer of domestic delivery company wherein domestic delivery fee is paid through computer used in financial institution;
stage wherein information regarding completion of delivery is provided to computer used for social commerce business as the buyer when domestic delivery process had been completed after delivery completion process is completed; and
stage wherein domestic delivery cannot be completed, delivery failure information is sent to computer used for social commerce business as the buyer wherein order is given to computer used by domestic delivery services company to send the product to social commerce business as the buyer.

22. Intermediate transaction method for multiple social commerce businesses of claim 13 wherein the stage (i) comprises:
stage wherein coupon and social commerce business evaluation module analyzes the transaction history when coupon transaction ends in order to evaluate the popularity of the coupon;
stage wherein coupon transaction history is analyzed to rate the popularity of the coupon;
stage wherein social commerce businesses as the seller is evaluated based on number of coupon transaction per cycle, coupon sales amount among others;
stage wherein social commerce businesses as the buyer is evaluated based on number of accepted coupon transaction per cycle, number of rejected transactions, number of orders, number of order cancellations, total amount of coupon sales payment and number of deferred payments to intermediate transaction company; and
stage wherein evaluation of coupon popularity and the result of evaluation for social commerce business as the buyer and the seller is sent to the computer of social commerce business as the buyer and the seller regularly.

23. Intermediate transaction system for multiple social commerce businesses of claim 2 wherein computer used for intermediate transaction comprises:
an external link server with the responsibility of interface and processing communication with computer used for social commerce business as the buyer, computer used in financial institutions, computer used by international delivery services company, electronic customs procedure computer and the computer used by domestic delivery services company;
a work process server with the responsibility of processing internal work process of the computer used for intermediate transaction;
a portal server that allows multiple social commerce businesses to download intermediate transaction request, information view and intermediary solution; and
an intermediary solution management server for maintaining and managing the intermediary solution.

24. Intermediate transaction system for multiple social commerce businesses of claim 2 wherein computer used for intermediate transaction further comprises social commerce business buyer selecting module which selects computer used for social commerce business as the buyer in case computer used for social commerce business as the seller wishes to sell coupons as intermediary in specific countries and specific areas.
